(19) United States
(12) Patent Application Publication
(10) Pub. No.: US 2004/0013894 A1
(43) Pub. Date: Jan. 22, 2004

(54) Thin-film component and method for producing said thin-film component

(76) Inventors: Volker Wingsch, Reutlingen (DE); Joachim Glueck, Renningen (DE)

Correspondence Address: KENYON & KENYON, ONE BROADWAY, NEW YORK, NY, 10004, US

(21) Appl. No.: 10/380,938

(22) PCT Filed: Jul. 5, 2002
(86) PCT No.: PCT/DE02/02466

(30) Foreign Application Priority Data
Jul. 19, 2001 (DE) 101 35 170.4

(51) Int. Cl. H05H 1/26

(52) U.S. Cl. 428/507; 428/500; 427/446

(57) ABSTRACT

A thin-film component and a method for manufacturing it are proposed, an insulation layer (20) and a resistance layer (30) being applied on a substrate (10), the insulation layer (20) being applied in liquid form on the membrane (10).

### BACKGROUND INFORMATION

The present invention relates to a method for manufacturing a thin-film component, and a thin-film component. In particular, the thin-film component is provided as a thin-film high-pressure sensor having a substrate upon which at least one functional layer, to be provided with contacts, is to be applied. Such high-pressure sensors are used in numerous systems in the motor vehicle, for example, for the direct gasoline injection. High-pressure sensors are also used in the field of automation technology. The functioning of these sensors is based on converting the pressure-induced mechanical deformation of a membrane into an electrical signal with the aid of a thin-film system. High-pressure sensors having such thin-film systems are already known from the German Patent 100 14 984. However, in practice it is known when working with such high-pressure sensors that the surface bearing the thin resistance layer, i.e. the measuring layer, is not sufficiently even.

### SUMMARY OF THE INVENTION

In contrast, the method of the present invention and the thin-film component of the present invention having the characterizing features of the independent claims have the advantage that problems because of an uneven surface, upon which the measuring layer would have to be deposited, are avoided, and therefore polishing and lapping of the steel-substrate surface prior to applying the measuring layer may be omitted.

Another advantage is that the insulation layer includes an insulating, organic material. It is thereby possible to save the costs of, for example, depositing an insulation layer with the aid of the PECVD method, and thus to reduce the costs for manufacturing the thin-film component.

Furthermore, it is advantageous that the material includes benzocyclobutene or hydrogensilsesquioxane. This makes it possible to produce particularly durable thin-film components using the manufacturing method according to the present invention. It is also advantageous that the material is applied with the aid of a sprayer through a mask or by a micro-dosing mechanism. It is thereby possible to provide a patterned application of the material in a simple manner.

It is further advantageous that, after being applied, the material is dried, and that the material is subsequently hardened. A particularly strong planarization of the existing uneven subsurface, and thus an even top surface which is very advantageous for the subsequently applied layers, is thereby achieved.

Polishing and lapping the surface of the substrate, provided, for instance, as a steel substrate, prior to applying the passivation layer and insulation layer, respectively, may be omitted.

### BRIEF DESCRIPTION OF THE DRAWING

Exemplary embodiments of the present invention are shown in the Drawing and are explained in detail in the following description. The Figures show:

FIG. 1 a manufacturing method according to the present invention;

FIG. 2 a first possibility for applying a material; and

FIG. 3 a second possibility for applying a material.

### DESCRIPTION OF THE EXEMPLARY EMBODIMENTS

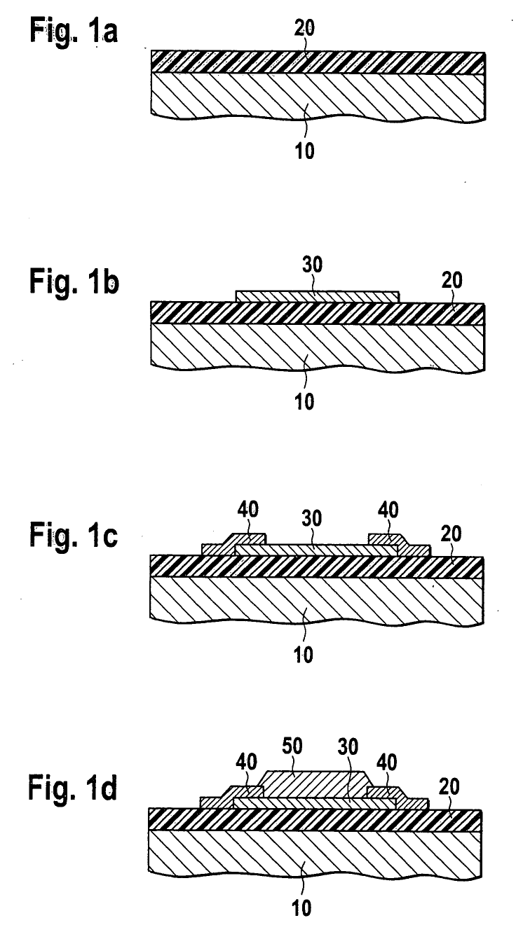

FIG. 1 shows a method of the present invention for manufacturing a high-pressure sensor which represents an example for a thin-film component according to the invention. To produce the thin-film component, first of all (FIG. 1a), an insulation layer 20 is applied over a large area on the surface of a steel membrane 10 to be coated, which is used as a substrate. Subsequently, the actual functional layer for strain gauges is applied over the entire surface. Strain gauges 30 are produced in a further step with the aid of a photolithographic patterning step (FIG. 1b). A contact layer 40 or a contact layer system 40, which is usually photolithographically patterned as well, is subsequently applied (FIG. 1c). The shadow-masking technique is also used as an alternative to photolithographically patterning contact layer 40. To set the desired electrical properties, a balancing operation is then often performed, in particular for adjusting the symmetry of a Wheatstone bridge formed by a plurality of patterned-out, piezoresistive strain gauges or resistive elements. In a further step (FIG. 1d), a passivation layer 50 is applied, which is also patterned either photolithographically or through the use of the shadow-mask technique.

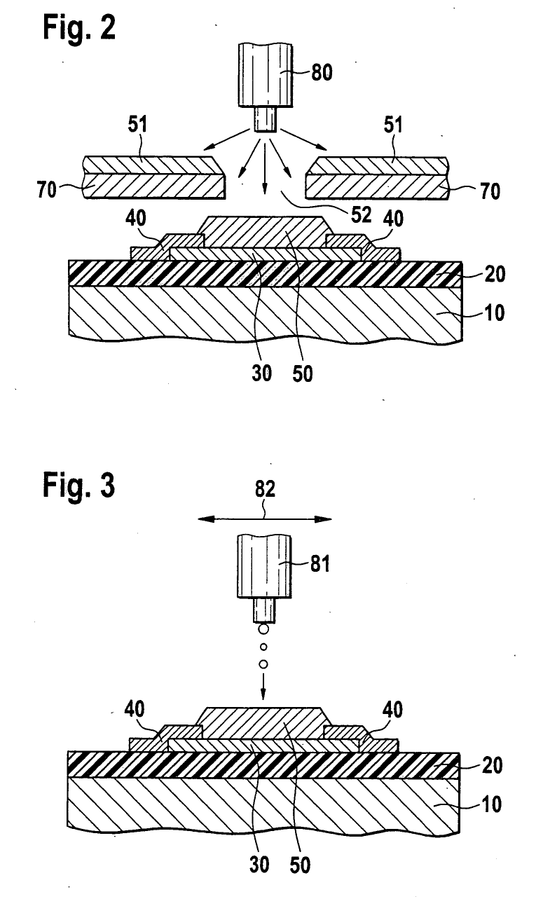

The subject matter of the present invention is essentially the manner of applying insulation layer 20 on steel membrane 10. According to the invention, the substrate, i.e. membrane 10, is made in particular of high-grade steel. As a rule, the substrate is produced, for example, by rotation processes. Thereupon, the surface of substrate 10 must be prepared by lapping and polishing the top side of the substrate for producing an even subsurface as a base for the resistance bridge subsequently applied using the thin-film technique. In this context, the peak-to-valley height of the steel surface is approximately 500 nm. The thickness of polysilicon layer 30, used as resistance material and applied subsequently to the application of insulation layer 20, also corresponds approximately to the same thickness. According to the invention, the approximately 10 μm thick substrate insulation layer 20 is not provided according to the related art using a PECVD method, but rather is provided by applying the insulation layer in liquid form. Insulating, organic materials such as BCB (benzocyclobutene) or HSQ (hydrogensilsesquioxane) are particularly suitable for this purpose. Insulation layer 20 is applied as an organic layer over the entire surface on the top side of high-grade steel substrate 10; according to the invention, a sprayer 80 shown in FIG. 2 or a micro-dosing mechanism 81 shown in FIG. 3 is used for this purpose.

FIG. 2 shows the application of a layer in liquid form on the thin-film component. A sprayer 80 having a spray head is provided for this purpose. Starting from sprayer 80, arrows indicate the moving direction of the liquid droplets emitted by sprayer 80. Situated between the component, which is shown in the bottom half of FIG. 2, and sprayer 80 is a mask 70 that, in the region of sprayer 80, has an opening 52 which permits the selective application of the material, present in liquid form, of the layer to be deposited. As mentioned, the component having membrane 10, insulation layer 20, resistance layer 30, contact layer 40 and passivation layer 50 is depicted in the bottom part of FIG. 2. FIG. 2 shows how passivation layer 50 is applied on the thin-film component with the aid of sprayer 80 and mask 70. A coating 51 made of the material of the layer to be deposited, i.e. in this case, passivation layer 50, results on the side of mask 70 pointing toward sprayer 80.

FIG. 3 shows the application of the material of a layer to be deposited, using a micro-dosing mechanism 81. Micro-dosing mechanism 81 is shiftable in the direction of an arrow provided with reference numeral 82. The micro-dosing mechanism, in the manner of a print head of an ink-jet printer, has the possibility of depositing on the thin-film component, comparatively small quantities of material, present in liquid form, which is intended to include the layer to be deposited. The thin-film component having membrane 10, insulation layer 20, resistance layer 30, contact layer 40 and passivation layer 50 is again shown in the bottom part of FIG. 3. As in FIG. 2, the application of passivation layer 50 is depicted.

According to the invention, both insulation layer 20 and passivation layer 50 are applied on substrate 10 using an insulating material, particularly an organic material, present in liquid form. However, the present invention also provides that merely one of these layers is applied using a material present in liquid form. Both substrate insulation 20 and passivation layer 50 are applied in liquid form in the same way as shown in FIGS. 2 and 3, using passivation layer 50 as an example. Insulation layer 20 is also applied in the same manner.

In the case of insulation layer 20, i.e. substrate insulation 20, the organic layer is applied over the entire top surface of high-grade steel substrate 10. After being applied, liquid insulation layer 20 runs uniformly on the surface of the steel substrate, and thus levels it. After the insulation layer has been applied, the liquid is dried, e.g. at 150° C. in air atmosphere, and subsequently hardened, e.g. at 475° C. in nitrogen atmosphere.

In the case of passivation layer 50, the organic layer is either sprayed on through a mask, the mask covering the contact pads, or else the passivation layer is applied with the aid of a micro-dosing system in such a way that contact pads 40, i.e. contacting layer 40, remains free. The subsequent drying and hardening of the passivation layer proceeds as described above in connection with insulation layer 20.

In the event that insulation layer 20 is deposited over the entire surface on the top side of the steel substrate using a sprayer 80, naturally no mask 70 is necessary in FIG. 2.

As an alternative to the two methods described for the patterned application of the organic passivation, according to the invention, it is likewise possible to deposit a photosensitive BCB layer over the entire surface, to dry it and expose it through a photomask, and subsequently to develop and harden it. Since the BCB layer is negatively photosensitive, the photomask covers contact pads 40, i.e. contacting areas 40, and permits an exposure and therefore chemical activation of the areas to be covered with the BCB. This photolithography method is particularly advantageous to use when very fine structures are to be produced.

The application of liquid insulation layer 20 and the subsequent drying and hardening produces a planarization of an existing uneven subsurface, and therefore makes a very advantageous even surface available for the layers subsequently applied. Polishing and lapping of the surface of steel substrate 10 prior to applying insulation layer 20 may be omitted, so that the costs for this process may be saved.

Furthermore, according to the invention, it is advantageously possible to use insulation layer 20 instead of a silicon dioxide insulation layer 20 which would have to be applied using the PECVD method. Because of that, according to the present invention, the use of the PECVD method for depositing insulation layer 20, and therefore also the costs for this method, are not necessary. Moreover, according to the invention, passivation layer 50 is provided in the form of a liquid material which replaces an SI_{X}N_{Y} passivation layer for which the PECVD method would likewise have to be used. According to the present invention, this is likewise not provided, so that the costs for the PECVD method may also be dispensed with for passivation layer 50.

What is claimed is:

1. A method for manufacturing a thin-film component, in which a resistance layer (30) is provided on an insulation layer (20), the insulation layer (20) being provided on a membrane (10) which is used as substrate (10) of the component,
wherein the insulation layer (20) is applied in liquid form on the membrane (10).

2. The method as recited in claim 1,
wherein the insulation layer (20) includes an insulating, organic material.

3. The method as recited in claim 2,
wherein the material includes benzocyclobutene (BCB) or hydrogensilsesquioxane (HSQ).

4. The method as recited in one of claims 1 through 3,
wherein the material is applied using a sprayer (80) or a micro-dosing mechanism (81).

5. The method as recited in one of claims 1 through 4,
wherein after being applied, the material is dried and subsequently hardened.

6. A thin-film component, manufactured according to a method as recited in one of the preceding claims.
